(19) United States
(12) Patent Application Publication
(10) Pub. No.: US 2017/0276159 A1
(43) Pub. Date: Sep. 28, 2017

(54) SUPPORT LEG ATTACHMENT ASSEMBLY

(71) Applicant: Sean ROBINSON, New York, NY (US)

(72) Inventor: Sean ROBINSON, New York, NY (US)

(21) Appl. No.: 15/080,884

(22) Filed: Mar. 25, 2016

(51) Int. Cl. F16B 12/52; F16B 1/00; A47B 13/00

(52) U.S. Cl. CPC F16B 12/52; A47B 13/003; F16B 1/00; F16B 2001/0035

(57) ABSTRACT

An improved support leg attachment assembly is provided. The support leg attachment assembly enables an easy transition of a portable structure, having a leg portion and a supported portion, between a detached storage configuration and an attached operative configuration, stably supporting the supported portion on the leg portion. The support leg attachment assembly provides two tenons on a proximal end the leg portion, and two mortises recessed along the supported portion, the two tenons and mortises dimensioned and adapted to snugly nest only upon an application of an engagement angle. Each of the two tenons and mortises providing contrasting materials for facilitating a long-lasting, effective support leg attachment assembly.

### BACKGROUND OF THE INVENTION

The present invention relates to furniture construction and, more particularly, to an improved support leg attachment assembly.

Furniture, containers and other structures standing on support legs are by definition (by having support legs) bulky. This makes them sometimes difficult to store and transport. Detachable support leg assemblies for enabling repeated attachment, detachment and reattachment of the support legs is known in the art. However, there is room for improvement in the ease of transitioning between the attachment, detachment and reattachment, while providing a stable attachment when using structures having support legs.

As can be seen, there is a need for an improved support leg attachment assembly for easily attaching and detaching a leg support that is stable when attached.

### SUMMARY OF THE INVENTION

In one aspect of the present invention, an improved leg support attachment assembly for removably attaching a leg portion to a supported portion includes a leg portion providing a first tenon communicating with a second tenon along a tenon shared surface, wherein the second tenon protrudes beyond a periphery of the first tenon; the supported portion having a structural surface, and wherein the supported portion provides a first mortise communicating with a second mortise along a mortise shared surface, wherein the mortise shared surface is recessed from the structural surface; a receiver plate defining a portion of the second mortise for snugly receiving and sandwiching the second tenon in the second mortise; and wherein two complementary portions of the tenon and mortise shared surface, respectively, are magnetically attracted.

In another aspect of the present invention, the improved leg support attachment assembly further includes a latch plate comprising at least the second tenon, wherein the latch plate and the receiving plate are made of a metallic material, wherein the two complementary portions comprise magnetically attracted magnets, wherein the first and second mortises are dimensioned to snugly receive the first and second tenons, respectively, wherein the receiving plate is dimensioned and adapted to require that when the second tenon is snugly received, it is done so at a non-perpendicular engagement angle of at least 15 degrees as measured between the tenon shared and the mortise shared surfaces.

These and other features, aspects and advantages of the present invention will become better understood with reference to the following drawings, description and claims.

### BRIEF DESCRIPTION OF THE DRAWINGS

FIG. 1 is a front perspective view of an exemplary embodiment of the present invention, shown in an operative configuration;

FIG. 2 is an exploded view of an exemplary embodiment of the present invention, shown in a storage configuration; and

FIG. 3 is a cross-sectional view of an exemplary embodiment of the present invention, taken along line 3-3 of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an improved support leg attachment assembly for easily transitioning portable structure, having a leg portion and a supported portion, between a detached storage configuration and an attached operative configuration, stably supporting the supported portion on the leg portion. The support leg attachment assembly provides two tenons on a proximal end the leg portion, and two mortises recessed along the supported portion, the two tenons and mortises dimensioned and adapted to snugly nest only upon an application of an engagement angle. Each of the two tenons and mortises providing contrasting materials for facilitating a long-lasting, effective support leg attachment assembly.

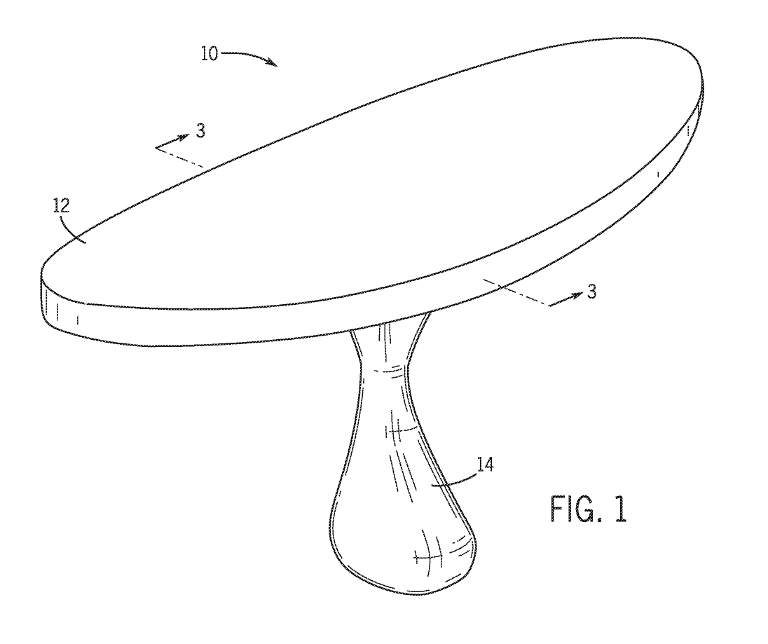

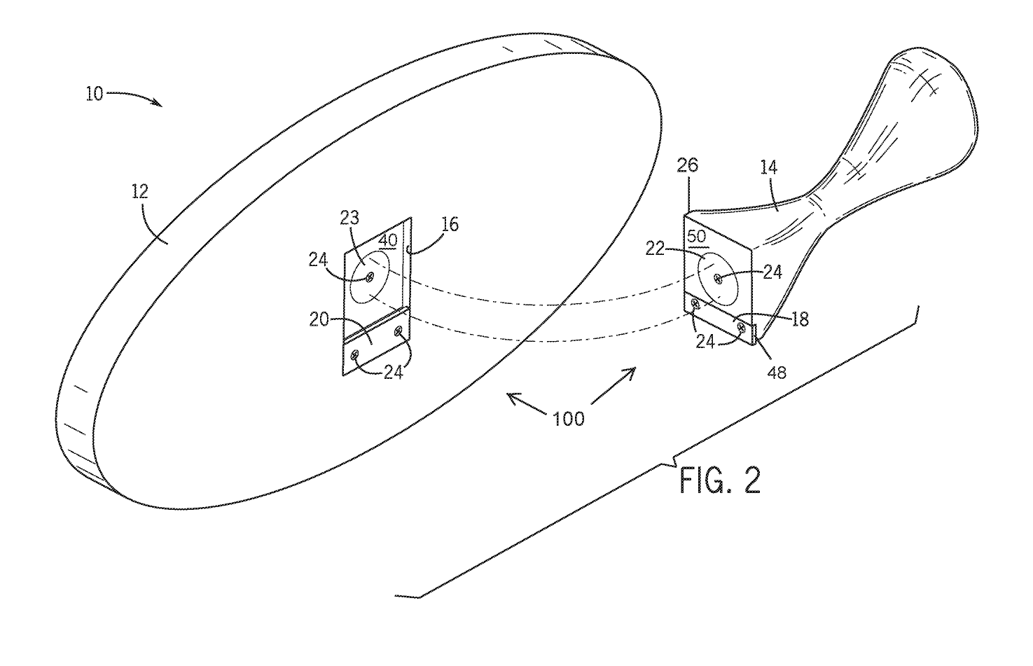

Referring to FIGS. 1 through 3, the present invention may include a leg support assembly 100 for a portable structure 10. The portable structure 10 may include a supported portion 12 and at least one leg portion 14, wherein each leg portion 14 is removably attached to the supported portion 12 by the leg support assembly 100. The leg support assembly 100 enables the portable structure 10 to be assembled into an operative configuration, as illustrated in FIG. 1, and disassembled into a storage configuration, as illustrated in FIG. 2. In certain embodiments, the portable structure 10 may be a seat with one leg portion 14, but may be other structural elements, such as trunks, tables, containers, shelves and the like, having a plurality of leg portions 14.

Each leg support assembly 100 may include a first mortise 16 communicating with a second mortise 28, both mortises 16, 28 recessed from a structural surface 30 of the supported portion 12, forming a shared mortise surface 40. The leg support assembly 100 may include a first tenon 26 and a second tenon 48 provided near a proximal end of the leg portion 14, forming a shared tenon surface 50. The first and second mortises 16, 28 are dimensioned and adapted to slidably receive the first and second tenons 26, 48, respectively.

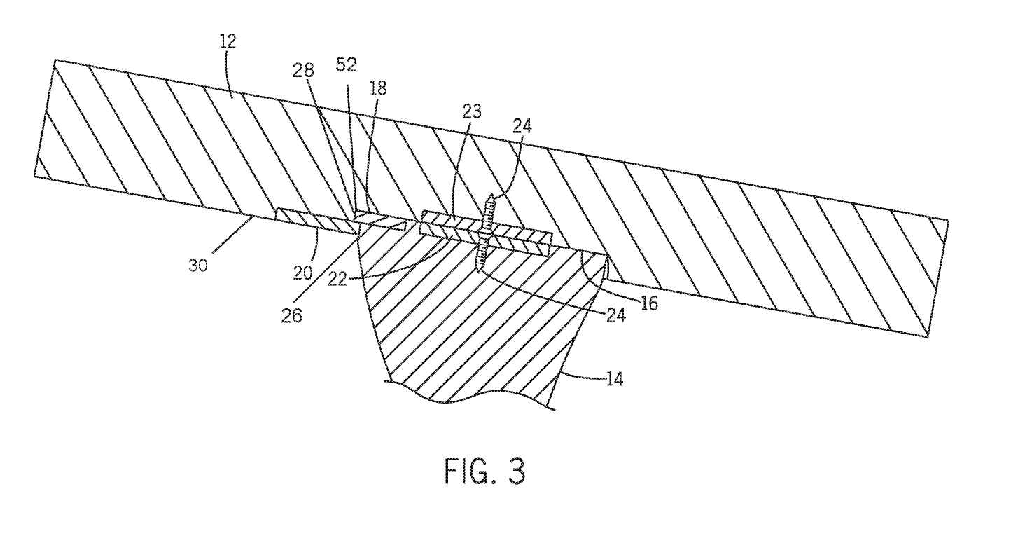

The second tenon 48 may extend along the shared tenon surface 50 so as to protrude beyond a periphery of the first tenon 26. In certain embodiments, the second tenon 48 may protrude beyond such periphery by about 3/16 of an inch. The second tenon 48 may include at least a portion of a latch plate 18. The latch plate 18 may be made of a metallic material, such as brass, as illustrated in FIG. 3. The supported portion 12 may provide a complementary receiver plate 20. The receiver plate 20 may be made of similar metallic material, such as brass, as the latch plate 18. The receiver plate 20 may be flush with the structural surface 30 and extend to define a second boundary of the second mortise 48.

A first distance between the shared mortise surface 40 and the structural surface 30 may be greater than a second distance between the shared mortise surface 40 and the second boundary, so that while the first tenon 26 may normally slide into the first mortise 16, the receiver plate 20 requires the second tenon 48 to angularly approach so as to nest into the second mortise 28. Meaning, both tenons 26, 48 need to be oriented at an engagement angle (the engagement angle measured relative to the longitudinal axis of the leg portion 14 to the longitudinal axis of the structural surface) when operatively engaging the two tenons and the two mortises simultaneously, preventing a perpendicular “normal” engagement. The engagement angle may be at least 15 degrees.

A mortise magnet 23 and a cooperating tenon magnet 22 may be disposed flush along the shared mortise surface 40 and the shared tenon surface 50, respectively, so that when in the operative configuration, the mortise and tenon magnets 23, 22 are magnetically attracted to each other. Each magnet 23, 22 may be separately attached to their respective supported and leg portion 12,14 by a fastener 24.

The snug nesting of the second tenon 48 and the second mortise 28, wherein the shared mortise surface 40 and the receiver plate 20 sandwich the second tenon 48, is adapted to prevent displacement of the second tenon 48 in a direction generally perpendicular to the shared mortise surface 40. The magnets 23, 22 prevent all movement, including pivotal movement about the periphery of the first tenon 26.

A method of using the present invention may include the following. The leg support assembly 100 disclosed above is provided on a portable structure 10. From the storage configuration to the operative configuration, a user manipulates the leg portion 14 so that the engagement angle relative to the supported portion 12 is sufficient for the second tenon 48 to slide into the second mortise 28 so as to snugly nest therein, and then the user further manipulates the leg portion 14 so the magnets 23, 22 magnetically engage and the first tenon 26 engages the first mortise 16, forming the operative configuration. From the operative to the storage configuration, the user must pivot the leg portion 14 along a distal edge 52 of the latch plate 18 so the user may disengage the magnets 23, 22 while sliding the second tenon 48 from the second mortise 28.

In the embodiments with the one leg portion 14 supporting the supported portion 12 that is a seat, as illustrated in FIG. 1, the following advantages of the present invention include: the seat/supported portion 12 may be designed with the latch plate 18 located in the “rear” of the seat to keep the single leg portion 14 from disengaging when there is pressure exerted from the front. (This is the pressure exerted when someone is kneeling with the seat under their rear in the correct position.) Pressure from the back causes the leg portion 14 to disengage instantly when breaking down the seat into the storage configuration to stow it away. (This is the pressure exerted when someone uses their hand to remove the leg.). Furthermore, the ability of a user to adjust their position (pivot on the ball of the leg) to find comfort, perfect balance and a perfect meditation posture for all body types is afforded by the one-legged seat.

It being understood that brass is low in weight, and corrosion resistant, but most importantly, brass is non-ferrous and therefore non-magnetic. This is important as the latch and receiver plates 18 and 20 must not interfere with the direct connection between the magnet in the leg portion 14 and the steel washer in the supported portion 12. Furthermore, brass latch and receiver plates 18 and 20 are much stronger than wood, which is the typical material of the portable structure, so that the latch and receiver plates 18 and 20 securely and can withstand repeated, striking contact as the leg portion 14 is assembled and removed, and they are capable of withstanding prolonged strong pressure without splintering or deforming.

It should be understood, of course, that the foregoing relates to exemplary embodiments of the invention and that modifications may be made without departing from the spirit and scope of the invention as set forth in the following claims.

What is claimed is:

1. An improved leg support attachment assembly for removably attaching a leg portion for a supported portion, comprising:
the leg portion providing a first tenon communicating with a second tenon along a tenon shared surface, wherein the second tenon protrudes beyond a periphery of the first tenon;
the supported portion having a structural surface, and wherein the supported portion provides a first mortise communicating with a second mortise along a mortise shared surface, wherein the mortise shared surface is recessed from the structural surface;
a receiver plate defining a portion of the second mortise for snugly receiving and sandwiching the second tenon in the second mortise; and
wherein two complementary portions of the tenon and mortise shared surface, respectively, are magnetically attracted.

2. The improved leg support attachment assembly of claim 1, further comprising a latch plate comprising at least the second tenon, wherein the latch plate and the receiving plate are made of a metallic material.

3. The improved leg support attachment assembly of claim 2, wherein the metallic material is brass.

4. The improved leg support attachment assembly of claim 1, wherein the two complementary portions comprise magnetically attracted magnets.

5. The improved leg support attachment assembly of claim 1, wherein the first and second mortises are dimensioned to snugly receive the first and second tenons, respectively.

6. The improved leg support attachment assembly of claim 5, wherein the receiving plate is dimensioned and adapted to require that when the second tenon is snugly received, it is done so at a non-perpendicular engagement angle.

7. The improved leg support attachment assembly of claim 5, wherein the engagement angle is at least 15 degrees as measured between the tenon shared and the mortise shared surfaces.
